(19) United States
(12) Patent Application Publication
(10) Pub. No.: US 2025/0350656 A1
(43) Pub. Date: Nov. 13, 2025

(54) IDENTIFYING MULTIPLEXED MEDIA STREAM DATA FLOWS USING PDU SET INFORMATION

(71) Applicant: InterDigital VC Holdings, Inc., Wilmington, DE (US)

(72) Inventors: Srinivas Gudumasu, Montreal (CA); Ahmed Hamza, Coquitlam (CA)

(73) Assignee: InterDigital VC Holdings, Inc., Wilmington, DE (US)

(21) Appl. No.: 18/662,579

(22) Filed: May 13, 2024

(51) Int. Cl. H04L 65/70; H04L 65/65; H04L 65/80

(52) U.S. Cl. CPC H04L 65/70; H04L 65/65; H04L 65/80

(57) ABSTRACT

Systems, methods, and instrumentalities may be configured for identifying multiplexed media stream data flows using packet data unit (PDU) set information. In examples, a device may receive a first stream identifier (ID) associated with a first PDU set. The first stream ID may be received in a PDU set marking header extension (HE). The device may determine, from the PDU set marking HE, that the first stream ID is associated with a first media stream. The device may send at least the first stream ID identifying the first media stream and the first PDU set associated with the first stream ID.

### BACKGROUND

Video coding systems may be used to compress digital video signals, for example, to reduce the storage and/or transmission bandwidth needed for such signals. Video coding systems may include, for example, wavelet-based systems, object-based systems, and/or block-based systems, such as a block-based hybrid video coding system. In extended reality applications, the mechanisms for providing control of degree of freedom boundaries may not be adequate.

### SUMMARY

Systems, methods, and instrumentalities may be configured for identifying multiplexed media stream data flows using packet data unit (PDU) set information. In examples, a device may receive a first stream identifier (ID) associated with a first PDU set. The first stream ID may be received in a PDU set marking header extension (HE). The device may determine, from the PDU set marking HE, that the first stream ID is associated with a first media stream. The device may send at least the first stream ID identifying the first media stream and the first PDU set associated with the first stream ID.

The first stream ID identifying the first media stream and the first PDU set associated with the first stream ID are sent to one or more of a user plane function (UPF), radio access network (RAN) node, or a media client. The device may generate the first stream ID. The first stream ID may be generated as part of one or more of a real time protocol (RTP) session negotiation or a provisioning session. The first stream ID may be received by a user plane function (UPF) from an application server (AS) or an application function (AF). The first stream ID may be received on a control plane. The first media stream associated with the first stream ID may be multiplexed into a single QoS flow.

The device may send an indication indicating that the first media stream is split into two or more quality of service (QOS) flows. The device may receive a second stream ID associated with a second PDU set. The device may determine that the second stream ID is associated with a second media stream. The device may send the second stream ID identifying the second media stream and the second PDU set associated with the second stream ID. The device may send an indication indicating that the first media stream is multiplexed with a second media stream. The first media stream and the second media stream may be multiplexed into a quality of service (QOS) flow. The device may send a list of stream IDs multiplexed with the first media stream.

Each feature disclosed anywhere herein is described, and may be implemented, separately/individually and in any combination with any other feature disclosed herein and/or with any feature(s) disclosed elsewhere that may be impliedly or expressly referenced herein or may otherwise fall within the scope of the subject matter disclosed herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram showing an example video encoder.

FIG. 3 is a diagram showing an example of a video decoder.

FIG. 4 is a diagram showing an example of a system in which various aspects and examples may be implemented.

FIG. 5 illustrates an example QoS Management in an example system (e.g., a 5G system).

FIG. 6 illustrates an example of multiplexed streams.

FIGS. 7A-7D illustrate various examples of generating multiplexed streams.

FIG. 8 illustrates an example of traffic over QoS flows where M SDF streams may be mapped to various QoS flows or N SDF streams may be mapped to a single QoS flow.

FIG. 9 illustrates an example of PDU set information associated with and/or carried in example QoS flows.

FIG. 10 illustrates an example one-byte RTP Header Extension for the marking of PDU Sets and the stream ID.

FIG. 11 illustrates an example one-byte RTP Header Extension for the marking of PDU Sets and the stream ID.

FIG. 12 illustrates an example two-byte RTP Header Extension for the marking of PDU Sets and the stream ID.

FIG. 13 illustrates an example two-byte RTP Header Extension for the marking of PDU Sets and the stream ID.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

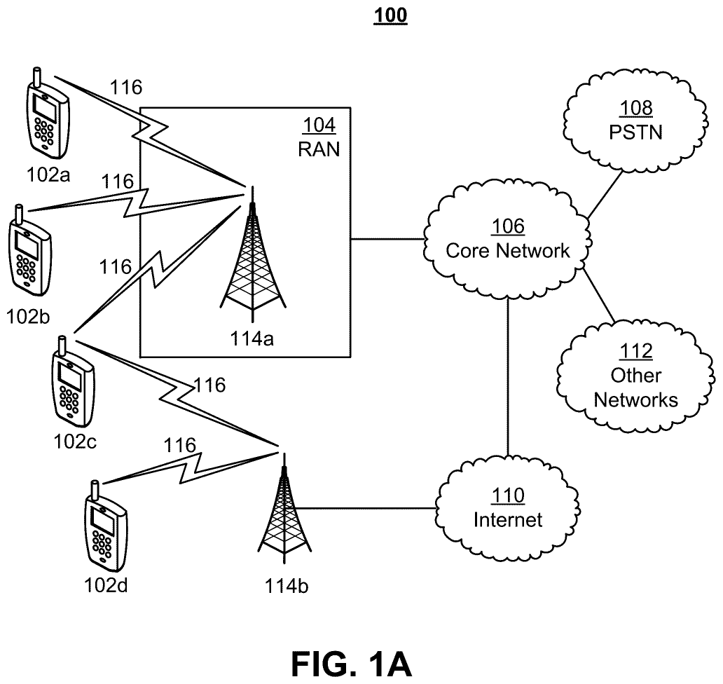

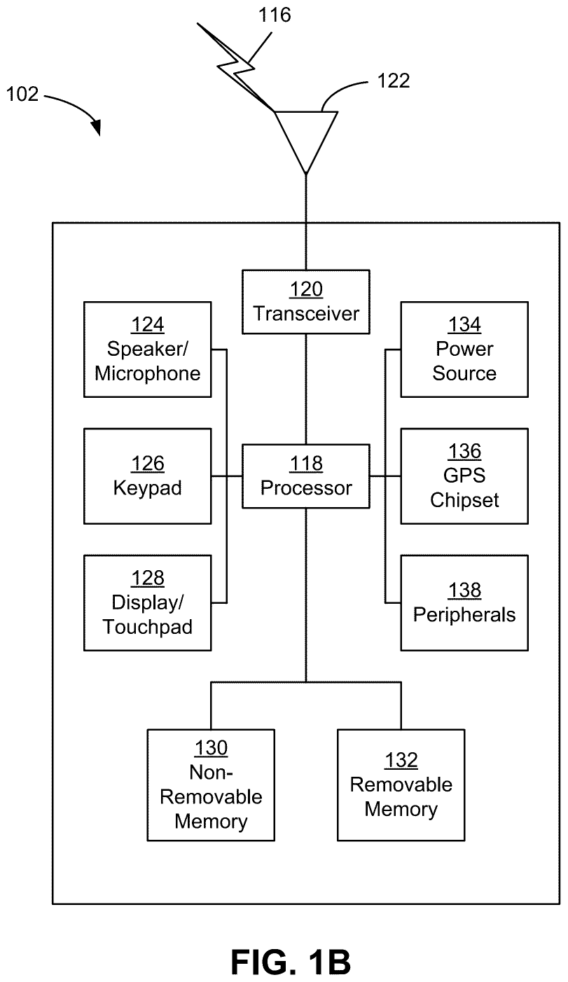

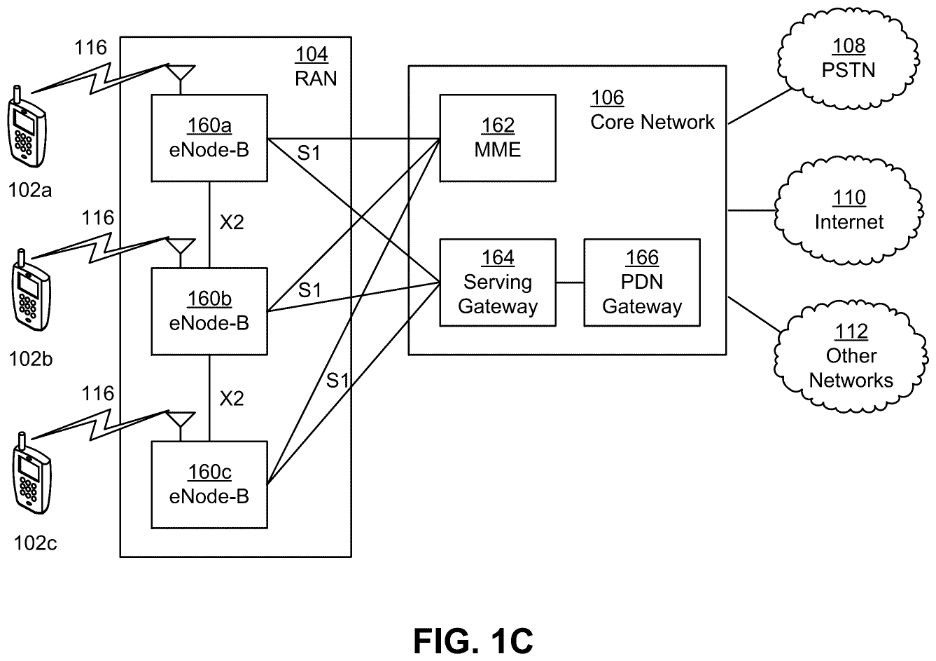

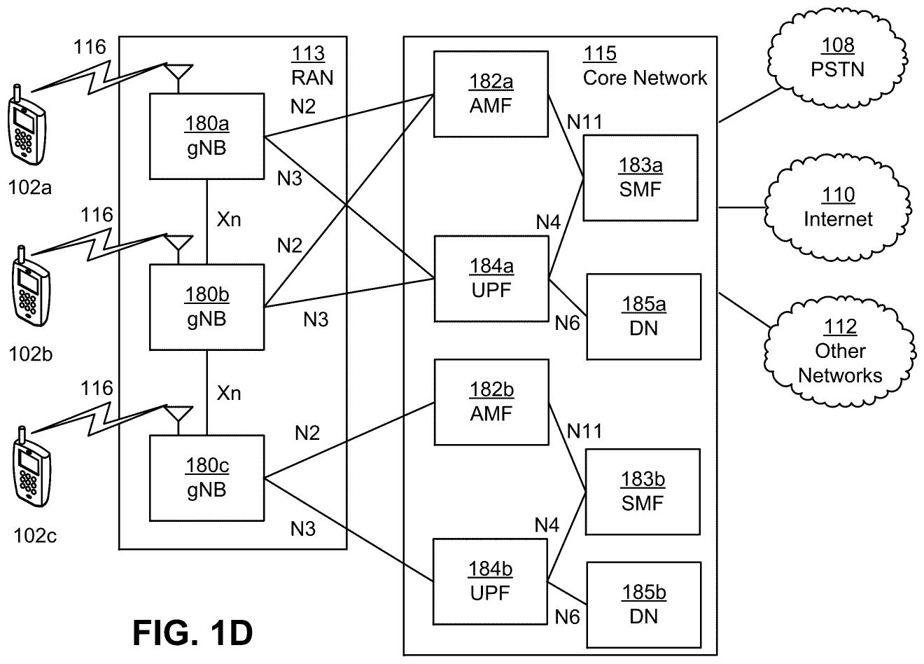

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b, and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples or embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

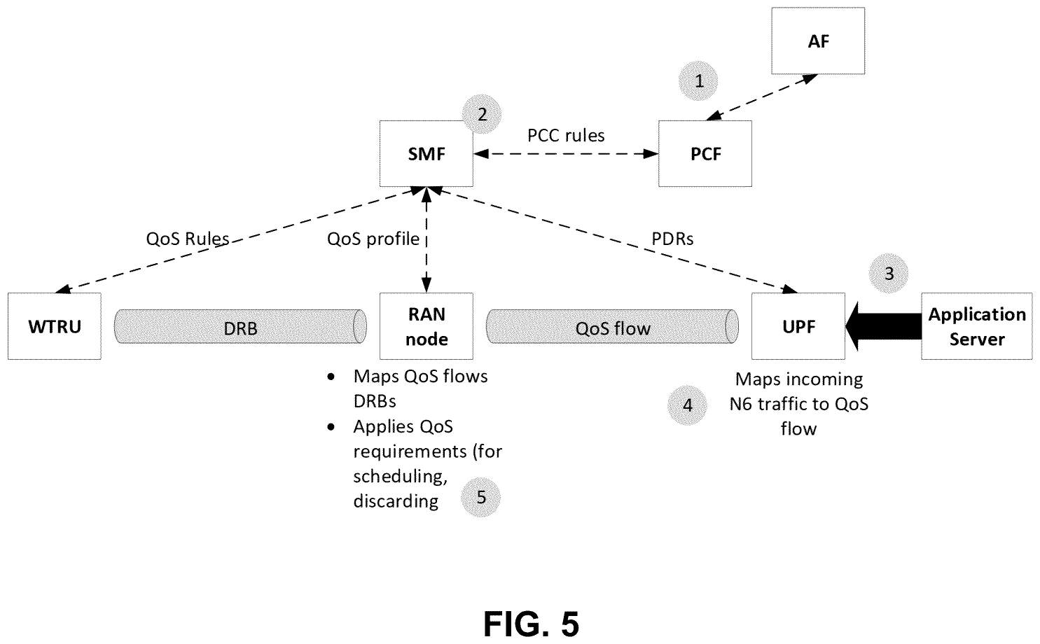

The aspects described and contemplated in this application may be implemented in many different forms. FIGS. 5-13 described herein may provide some embodiments, but other embodiments are contemplated. The discussion of FIGS. 5-13 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

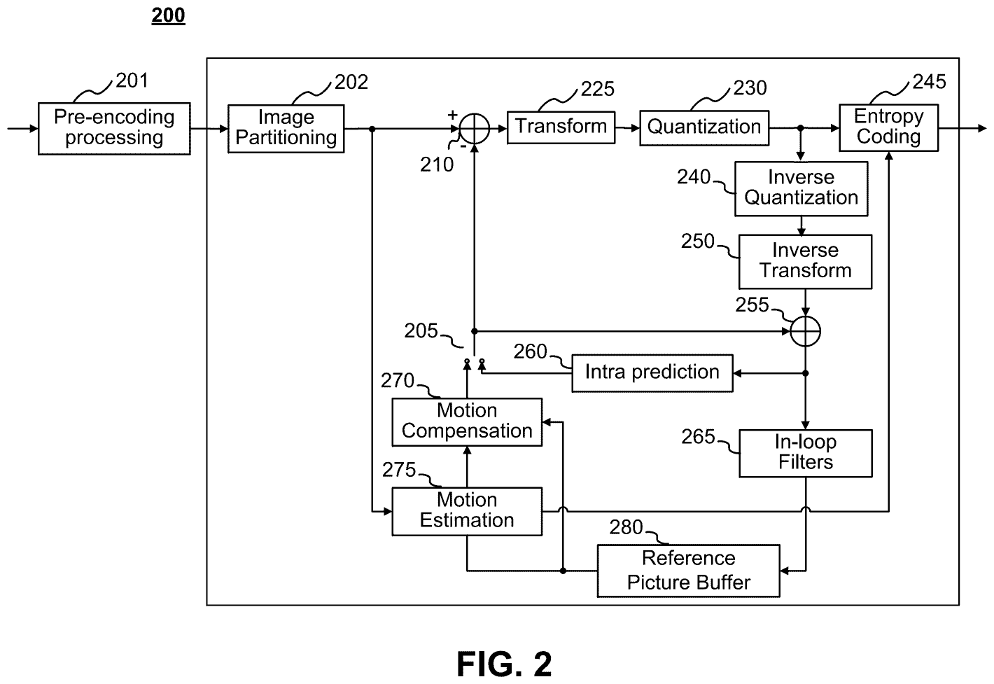

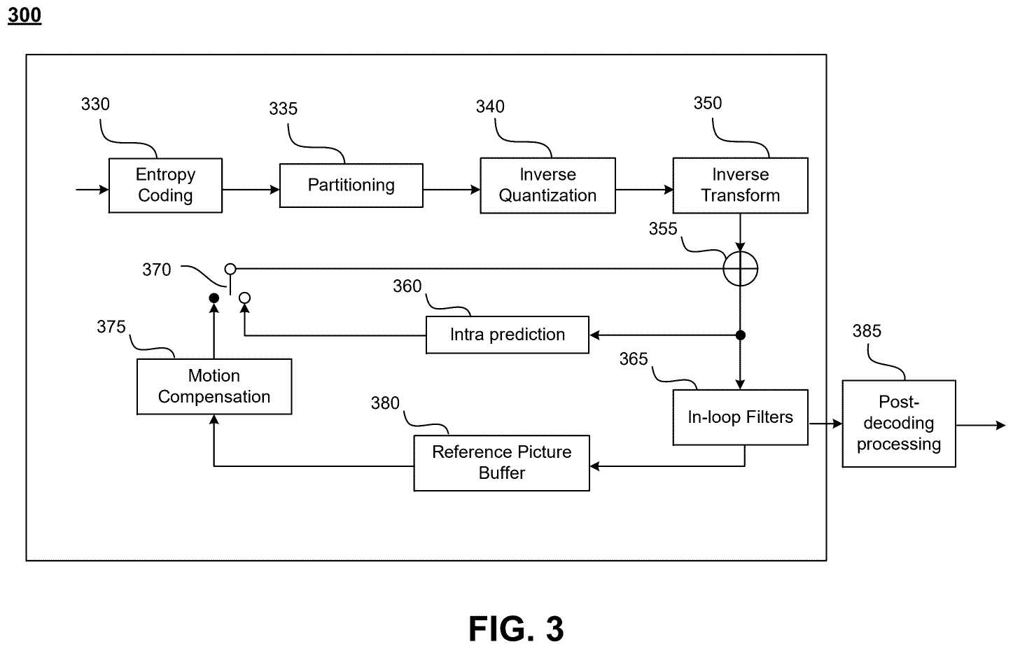

Various methods and other aspects described in this application may (for example, be used to) modify modules, for example, pre-encoding processing 201, intra prediction 260, entropy coding 245 and/or entropy decoding modules 330, intra prediction 360, post-decoding processing 385, of a video encoder 200 and a video decoder 300 as shown in FIG. 2 and FIG. 3 respectively. Moreover, the subject matter disclosed herein presents aspects that are not limited to WC or HEVC, and may be applied, for example, to any type, format or version of video coding, whether described in a standard or a recommendation, whether pre-existing or future-developed, and extensions of any such standards and recommendations (e.g., including VVC and HEVC). Unless indicated otherwise, or technically precluded, the aspects described in this application may be used individually or in combination.

Various numeric values are used in examples described the present application, such as minimum and maximum value ranges (for example, 0 to 1, 0 to N or 0 to 255), bit values for indications or determinations, default values, ID numbers (for example, for adaptation IDs), etc. These and other specific values are for purposes of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 may also generally perform video decoding as part of encoding video data. For example, the encoder 200 may perform one or more of the video decoding steps presented herein. The encoder reconstructs the decoded images, for example, to maintain synchronization with the decoder with respect to one or more of the following: reference pictures, entropy coding contexts, and other decoder-relevant state variables.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

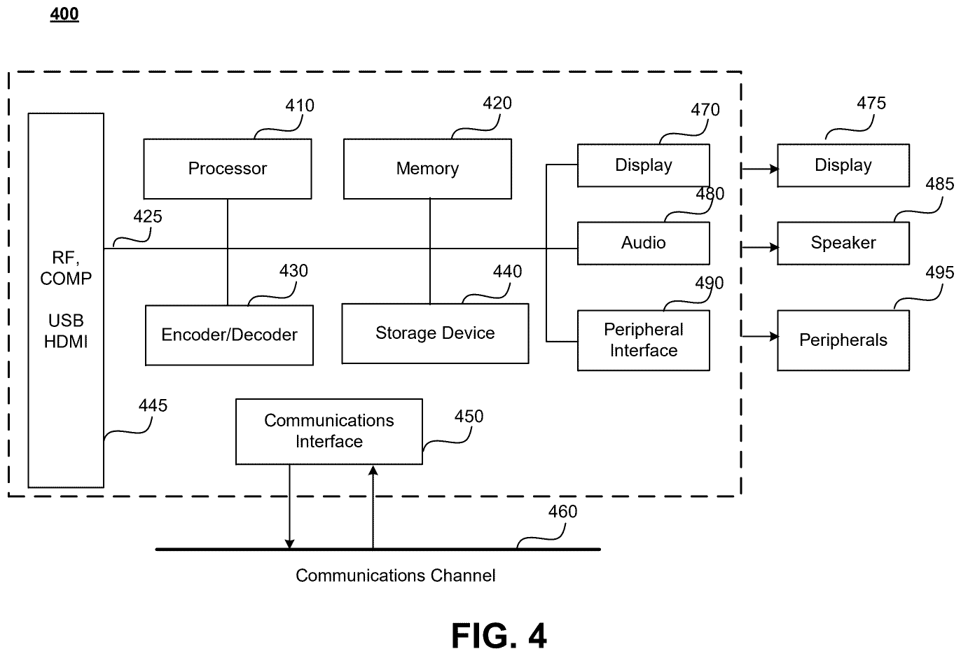

FIG. 4 is a diagram showing an example of a system in which various aspects and embodiments described herein may be implemented. System 400 may be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various embodiments, the system 400 is communicatively coupled to one or more other systems, or other electronic devices, via, for example, a communications bus or through dedicated input and/or output ports. In various embodiments, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various embodiments, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 410 and/or the encoder/decoder module 430 is used to store instructions and to provide working memory for processing that is needed during encoding or decoding. In other embodiments, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as, for example, MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various embodiments, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the data stream as necessary for presentation on an output device.

Various elements of system 400 may be provided within an integrated housing. Within the integrated housing, the various elements may be interconnected and transmit data therebetween using suitable connection arrangement 425, for example, an internal bus as known in the art, including the Inter-IC (I2C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various embodiments, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these embodiments is typically connected to an access point or router that provides access to external networks including the Internet for allowing streaming applications and other over-the-top communications. Other embodiments provide streamed data to the system 400 using a set-top box that delivers the data over the HDMI connection of the input block 445. Still other embodiments provide streamed data to the system 400 using the RF connection of the input block 445. As indicated above, various embodiments provide data in a non-streaming manner. Additionally, various embodiments use wireless networks other than Wi-Fi, for example a cellular network or a Bluetooth network.

The system 400 can provide an output signal to various output devices, including a display 475, speakers 485, and other peripheral devices 495. The display 475 of various embodiments includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples of embodiments, one or more of a stand-alone digital video disc (or digital versatile disc) (DVR, for both terms), a disk player, a stereo system, and/or a lighting system. Various embodiments use one or more peripheral devices 495 that provide a function based on the output of the system 400. For example, a disk player performs the function of playing the output of the system 400.

In various embodiments, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various embodiments, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various embodiments in which the display 475 and speakers 485 are external components, the output signal may be provided via dedicated output connections, including, for example, HDMI ports, USB ports, or COMP outputs.

The embodiments may be carried out by computer software implemented by the processor 410 or by hardware, or by a combination of hardware and software. As a non-limiting example, the embodiments may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations.

As further embodiments, in one example “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, such as syntax elements that may be indicated in discussion or figures presented herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

During the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment,” “an embodiment,” “an example,” “one implementation” or “an implementation,” as well as other variations thereof, means that a particular feature, structure, characteristic, and so forth described in connection with the embodiment is included in at least one embodiment. Thus, the appearances of the phrase “in one embodiment,” “in an embodiment,” “in an example,” “in one implementation,” or “in an implementation”, as well any other variations, appearing in various places throughout this application are not necessarily all referring to the same embodiment or example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in some embodiments the encoder signals (e.g., to a decoder) an MPD, adaptation set, a representation, a preselection, G-PCC components, a G-PCCComponent descriptor, a G-PCC descriptor or an essential property descriptor, a supplemental property descriptor, a G-PCC tile inventory descriptor, G-PCC static spatial regions descriptor, GPCCTileld descriptor GPCC3DRegionID descriptor, among other descriptors, elements and attributes, metadata, schemas, etc. (for example, as disclosed herein), etc. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, signaling may be used without transmitting (implicit signaling) to simply allow the decoder to know and select the particular parameter. By avoiding transmission of any actual functions, a bit savings is realized in various embodiments. It is to be appreciated that signaling may be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium. The following acronyms in Table 1 may be used herein.

TABLE 1
Acronyms described herein.

| | |
|---|---|
| 5GS | 5G System |
| 5QI | 5G QoS Identifier |
| AF | Application Function |
| API | Application Programing Interface |
| AS | Application Server |
| CSRC | Contributing Source |
| DL | Downlink |
| DRB | Data Radio Bearer |
| DSCP | Differentiated Service CodePoint |
| EDB | End of Data Burst |
| FAR | Forward Action Rule |
| FEC | Forward Error Correction |
| GTP-U | Generic Tunneling Protocol User Plane |
| ID | Identifier |
| IP | Internet Protocol |
| MASQUE | Multiplexed Application Substrate over QUIC Encryption |
| MOQ | Media Over QUIC |
| PCC | Policy and Charging Control |
| PCF | Policy Control Function |
| PDCP | Packet Data Convergence Protocol |
| PDR | Packet Detection Rule |
| PDU | Protocol Data Unit |
| PSA UPF | PDU Session Anchor UPF |
| PSDB | PDU Set Delay Budget |
| PSER | PDU Set Error Rate |
| PSI | PDU Set Importance |
| PSIHI | PDU Set Integrated Handling Indication |
| PSN | PDU Sequence Number |
| PSSN | PDU Set Sequence Number |
| PSSize | PDU Set Size |
| QFSID | QoS flow Stream ID |
| QoS | Quality of Service |
| QUIC | The QUIC protocol (QUIC is a name, not an acronym) |
| RAN | Radio Access Network |
| RLC | Radio Link Control |
| RTP | Real-Time Protocol |
| RTP HE | Real-Time Protocol Header Extension |
| SDP | Session Description Protocol |
| SMF | Session Management Function |
| SSRC | Synchronization source |
| ToS/TC | Type of Service/Traffic Class |
| UDP | User Datagram Protocol |
| UE | User Equipment |
| UPF | User Plane Function |
| UL | Uplink |
| XR | Extended Reality |
| XRM | XR Media |

Features described herein may be associated with QoS management in an system (e.g., a 5G System). In an example system, QoS management may be based on QoS flows. PDUs (e.g., all PDUs) in a QoS flow may receive the same treatment in the RAN and in the UPFs in the core network. The Qos Flow may be the finest granularity of QoS differentiation in the PDU Session. A QoS flow may have one or more of the following QoS requirements: 5QI (including resource type, Priority Level, PDB, PER, Averaging Window, Maximum Data Burst Volume), ARP, RQA, Notification Control, Flow Bit Rates (MFBR, GBR), Aggregate Bit Rates, or Maximum Packet Loss Rates. The overall procedure to enable QoS management in the system is shown in FIG. 5 and described below.

FIG. 5 illustrates an example QoS Management in an example system (e.g., a 5G system). At 1, the Application Function (AF) may provision the network (e.g., PCF) with QoS requirements of the traffic flows, for example, using a NEF service API such as Nnef_AFsessionWithQoS_Create. At 2, QoS information may be used by the PCF to configure PCC rules. Based on the rules configured in the PCF, the SMF may configure the RAN node with a QoS profile, the UPF with PDRs, and the WTRU with QoS rules. At 3, a PDU may arrive at the UPF (e.g., over the N6 interface). At 4, using the configured PDRs, the UPF may map the traffic to a QoS flow. The UPF may create a tunnel to the RAN node and send the arriving PDU to the RAN node in a GTP-U packet. At 5, the RAN node may use the configured QoS profile to determine how to manage the GTP-U packet. This management may include how to schedule the packet to the WTRU and whether the packet should be discarded. If scheduled, the packet may be transmitted to the WTRU on a configured Data Radio Bearer (DRB).

Additional processing may be associated with XR media traffic. For example, the XR traffic may be transmitted as PDU sets. The QoS profile may have requirements that target PDU sets. The header of the GTP-U PDU may carry PDU set information.

A single XR stream may be mapped to a QoS flow. Features described herein may be associated with PDU Set handling. To support PDU Set based QoS handling, the PSA UPF may identify PDUs that belong to PDU Sets and determines PDU Set Information which it sends to the NG-RAN in the GTP-U header. The PDU Set information may be used by the NG-RAN for PDU Set based QoS handling.

The PDU Set Information may include one or more of the following: PDU Set Sequence Number, Indication of End PDU of the PDU Set, PDU Sequence Number within a PDU Set, PDU Set Size in bytes, or PDU Set Importance, which identifies the relative importance of a PDU Set compared to other PDU Sets within a QoS Flow.

To determine the PDU set information, the PSA UPF may rely on information carried in the received packets and/or on implementation. For example, if the XRM traffic is carried over RTP, the RTP header may include on or more of the following:

The RTP header may include an End PDU of the PDU Set [E] (1 bit): this field may be a flag that is set to 1 for the last PDU of the PDU Set and set to 0 for (e.g., other) PDUs of the PDU Set.

The RTP header may include an End of Data Burst [EDB] (3 bits): The EDB field may be 3 bits in length and may indicate the end of a Data Burst. The 3 bits may encode the End of Data Burst indication as per the encoding and guidelines described herein.

The RTP header may include a PDU Set Importance [PSI] (4 bits): The PDU Set Importance field may indicate the importance of this PDU Set compared to other PDU Sets within the same QoS flow. Lower values may indicate a higher importance PDU Set, with the highest importance PDU Set indicated by 0 and the lowest importance PDU Set indicated by 15.

The RTP header may include a PDU Set Sequence Number [PSSN] (10 bits): The field may encode the sequence number of the PDU Set to which the current PDU belongs acting as a 10-bit numerical identifier for the PDU Set.

PDU Sequence Number within a PDU Set [PSN] (6 bits): The sequence number of the current PDU within the PDU Set. The PSN may be set to 0 for the first PDU in the PDU Set and incremented monotonically for a PDU in the PDU set in order of transmission from the sender.

The RTP header may include a PDU Set Size [PSSize] (24 bits): The PDU Set Size may indicate the total size of PDUs of the PDU Set to which this PDU belongs. This field may be optional and subject to an SDP signaling offer/answer negotiation, where the Application Server may indicate whether it will be able to provide the size of the PDU Set for that RTP stream. If not enabled, the field may not be present. If enabled, and the Application Server is unable to determine the PDU Size for a particular PDU Set, it may be set to 0 in PDUs of that PDU Set. The PSSize may indicate the size of a PDU Set including RTP/UDP/IP header encapsulation overhead of its corresponding PDUs. The PSSize may be expressed in bytes.

The network may be configured with PDU set QoS requirements (or information). This information may be associated per QoS flow, and as a result, the PDU set QoS requirements may be the same for (e.g., all) PDU sets carried in a QoS flow. One or more of the following PDU set QoS requirements may be associated with XRM traffic flows: PDU Set Delay Budget (PSDB): The PDU Set Delay Budget may indicate an upper bound for the delay that a PDU Set may experience for the transfer between the WTRU and the N6 termination point at the UPF, e.g., the duration between the reception time of the first PDU (at the N6 termination point for DL or the WTRU for UL) and the time when all PDUs of a PDU Set have been successfully received (at the WTRU for DL or N6 termination point for UL); PDU Set Error Rate (PSER): The PDU Set Error Rate may indicate an upper bound for the rate of PDU Sets that have been processed by the sender of a link layer protocol (e.g. RLC in RAN of a 3GPP access) but that are not successfully delivered by the corresponding receiver to the upper layer (e.g. PDCP in RAN of a 3GPP access); or PDU Set Integrated Handling Information (PSIHI): The PDU Set Integrated Handling Information may indicate whether all PDUs of the PDU Set are needed for the usage of the PDU Set by the application layer in the receiver side.

PDU set traffic characteristics may be provided by the core network to the NG-RAN in order to configure WTRU power saving management scheme for connected mode DRX. The PDU set traffic characteristics may include: UL and/or DL Periodicity; N6 Jitter Information associated with the DL Periodicity; or Indication of End of Data Burst

The UL and/or DL Periodicity and N6 Jitter Information associated with the DL Periodicity may be provided by the core network to NG RAN via TSCAI. The core network may get this information from the AF, or it may derive some of these at the UPF. The information may be transferred to the NG RAN via the SMF and AMF. Features described herein may be associated with multiplexed streams.

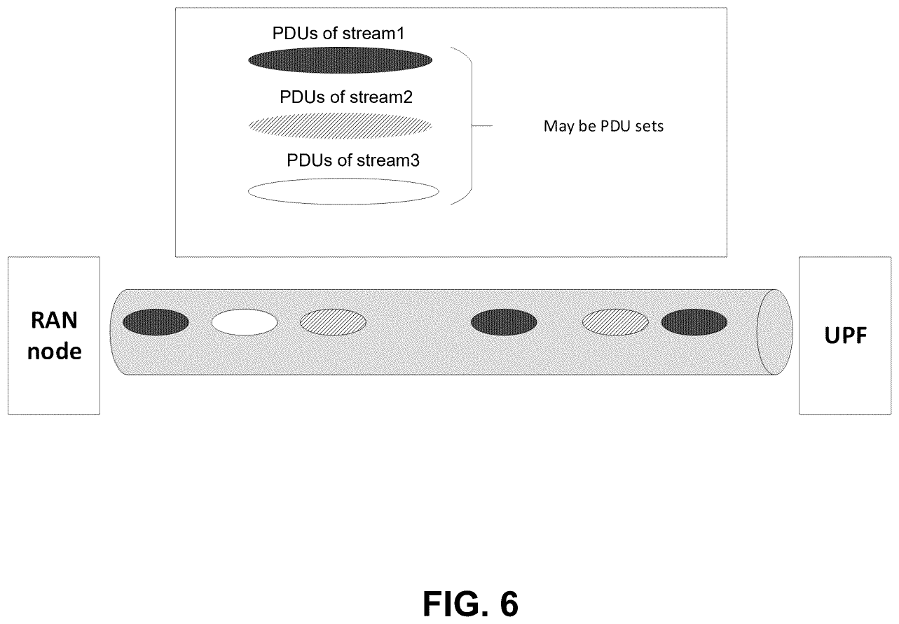

FIG. 6 illustrates an example of multiplexed streams. XR Media services may include multiple types of flows, e.g., video streams, audio stream, haptic, other metadata, or sensor data for more immersive experience. To enable these immersive services, media types data may be multiplexed into a single data flow before arriving at the system ingress (e.g., 5GCS ingres). A stream may have its own PDU set properties. The QoS flow may carry multiplexed streams, as illustrated in FIG. 6. Various multiplexed streams may have different QoS characteristics, periodicities, and/or PDU set properties.

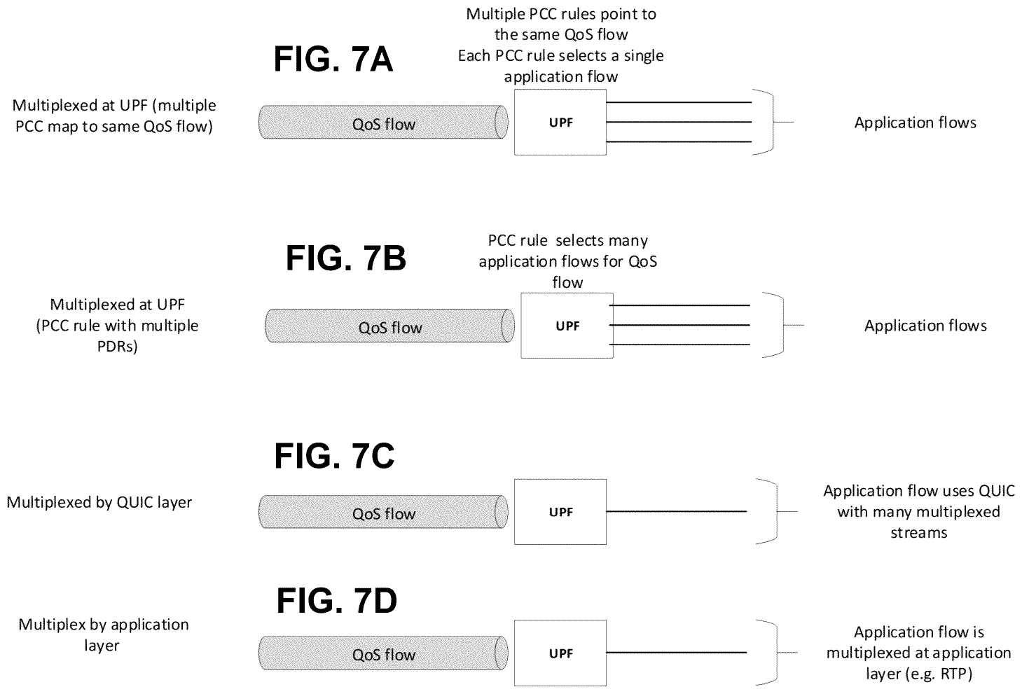

FIG. 7A-7D illustrate various examples of how multiplexed streams may be created. As illustrated in various examples provided in FIGS. 7A-7D, multiplexing of the XR streams may occur at one or more of the following: at application layer e.g. RTP (e.g., as illustrated in FIG. 7D), at transport layer (e.g., QUIC) (e.g., as illustrated in FIG. 7C), based on PCC rules provided to UPF (e.g., as illustrated in FIGS. 7A and 7B). As illustrated in FIG. 7A, the QoS flow may be multiplexed at an application layer where multiple PCC points may point to the same QoS flow. In such an example, each PCC rule may select a single application flow. As illustrated in FIG. 7B, the QoS flow may be multiplexed at an application layer where a PCC rule may select many application flows for a QoS flow.

As illustrated in FIG. 7C, an application flow may use (e.g., be multiplexed by) a transport layer (e.g., a QUIC layer). As illustrated in FIG. 7C, the application flow may use QUIC with many multiplexed streams.

As illustrated in FIG. 7D, an application flow may be multiplexed at an application layer (e.g., RTP).

Features described herein may be associated with how to identify multiplexed traffic flows with different QoS requirements within a single transport connection; how to do QoS Flow mapping for traffic flows with different QoS requirements; whether and what information may be provided from AF for traffic detection; or whether and how an AF may provide QoS requirements of different traffic flows to the system.

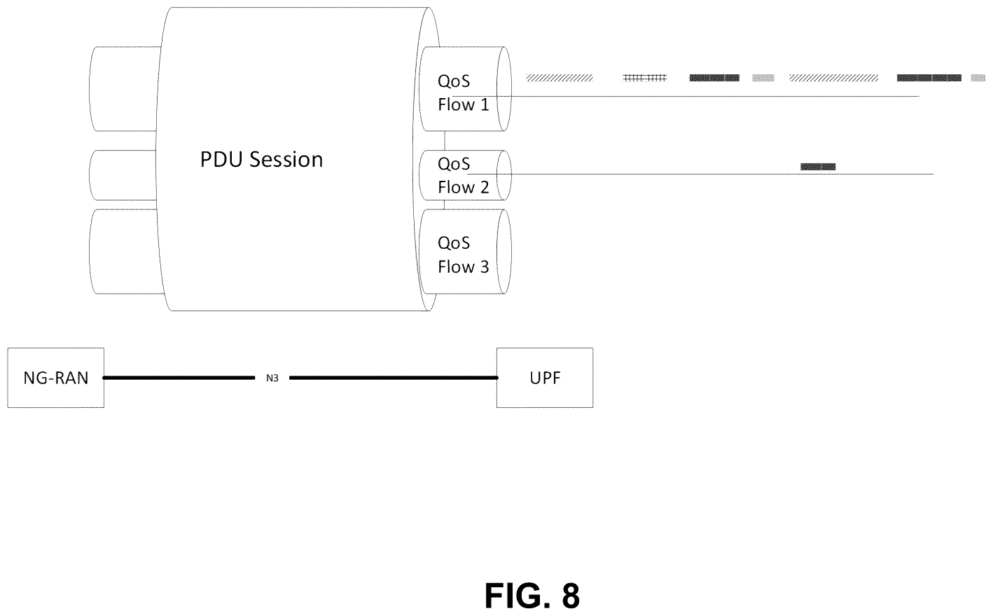

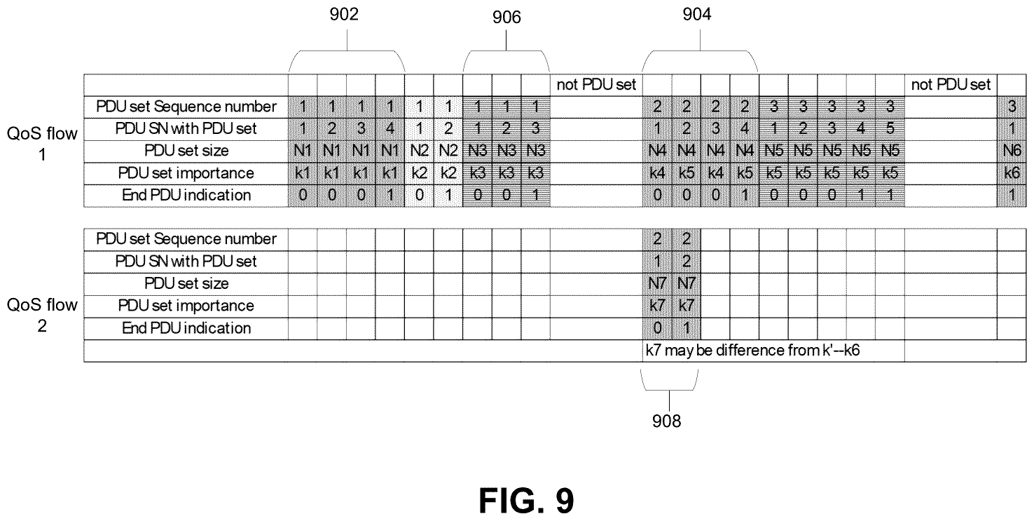

Various multiplexing options may be provided to map SDFs to QoS flows. For example, in multiplexing option1, one SDF stream per QoS flow may be provided. In multiplexing option2, M SDF streams may be provided per QoS flow. In multiplexing option2, M streams may have the same QoS parameters and PDU Set QoS parameters and similar PDU set traffic characteristics. In multiplexing option3, M SDF streams per QoS flow may be provided. In multiplexing option3, M streams may have the same QoS parameters and PDU Set QoS parameters, and may have different PDU set traffic characteristics. In multiplexing option4, M SDF streams per QoS flow may be provided. In multiplexing option4, M streams may have the same QoS parameters, and may have different PDU Set QoS parameters and different PDU set traffic characteristics. M streams may have PDU set QoS parameters that are the same and that are different. In multiplexing Option5, parts of N SDF streams may be mapped to a QoS Flow. In multiplexing option5, the N streams may have the same QoS parameters and one or more PDU Set QoS parameters (e.g., the N streams may have the same PSI). The N streams may have the same or different PDU set characteristics. FIG. 8 illustrates an example of traffic over QoS flows with Multiplexing Option4 or Multiplexing Option5. FIG. 9 illustrates an example of PDU Set information that may be carried in example QoS flows. As illustrated in FIG. 9, all PDUs sets associated with a stream (902, 904) may be included in the QoS flow 1, while PDU sets associated with another stream (906, 908) may be split across the QoS flow 1 and the QoS flow 2.

PDU sets may arrive at the UPF from different streams (e.g., as indicated by different patterns), and the PDU Set information carried in these PDUs may not be correlated. The UPF and NG RAN may keep track of the PDU sets arriving from different media streams.

In examples, a QoS flow may be associated with PDUs from multiple streams. If traffic is considered over a (e.g., one) QoS flow, the QoS flow may include a mix of traffic from possible different streams and from different applications or sources. Based on the UPF or RAN node getting the PDU set information on the QoS flows, the UPF or RAN may need to know which PDU set information applies to which PDU sets and which PDU sets belong to a specific media stream.

Mapping of streams to QoS flows may result in streams that are split across one or more Qos flows. The Application Function (AF) may signal the UPF about the presence of data from multiple streams, whether the data from a specific stream is split into two or more QoS flows, and how to identify the PDU sets coming from a specific media stream.

When the Application server is transmitting PDU sets data belonging to different media streams in a multiplexed flow, the UPF may identify the PDU sets belonging to the respective streams, such that the UPF may map the PDU sets belonging to a specific stream when the PDU sets are transmitted over a single QoS flow or multiple QoS flows.

When a stream/SDF is split across 2 or more QoS flows, PDU sets of the stream may be going over QoS flow 1 and (e.g., some) may be going over QoS flow 2, etc. The UPF and/or the RAN node may deal with (e.g., process) gaps in the PDU set SN for a stream.

As described herein, stream, data flow, or sub-flow may be used interchangeably. A data flow may represent a traffic from an application source (e.g., application server or WTRU). For example, the data flow may be a video data flow, an audio data flow, or a haptic data flow. The data flows may have a relationship in time. For example, an audio data flow may be time synchronized with a video data flow.

In the following, the term stream may refer to a service sub-flow (e.g., a media service sub-flow) multiplexed in a service flow (e.g., multiplexed in an application connection). Stream and XR stream may be used interchangeably.

In the following, the streams may be assumed to be XR streams, for example, for illustrative purposes. It should be understood that the streams may be of any type. The term end-to-end connection may be used to refer to a connection between a WTRU and an application server used to transfer one or multiple data flows. For example, the end to end connection may be an RTP session. The end to end connection may be a QUIC connection where multiple streams are multiplexed. The different streams may be audio and video, or different video layers (e.g., with a video layer on its own stream).

A PDU Set may refer to one or more PDUs carrying the payload of one unit of information generated at the application level (e.g. frame(s) or video slice(s) etc. for extended Reality (XR) Services). A PDU set may have one PDU or multiple PDUs. The PDUs of the PDU Set may carry PDU set information.

PDU Set Information may refer to information that may be carried with the PDUs of the PDU set, and which help to characterize the PDU set. Examples may include the PDU set size, the PDU set sequence number, the End PDU indication, etc.

PDU Set QoS requirements may refer to QoS requirements that deal with PDU set properties of the PDU set. For example, the PDSB, PSER, PSIHI.

Multi-modal data may refer to data from devices/sensors or the output data to destinations (e.g. one or more WTRUs) for the same task or application. Multi-modal data may include more than one single-modal data, and there may be a (e.g., strong) dependency among a single-modal data. Single-modal data may be seen as a (e.g., one) type of data.

A stream may have a (e.g., different) PDU set QoS characteristic and/or PDU set QoS parameters and that, a stream may be identified individually by the AS, AF, UPF and WTRU. Examples described herein may apply to a group of streams that have similar PDU set QoS characteristics and/or PDU set QoS parameters and may be treated as a Stream Group.

Examples described herein may be associated with identifying multiplexed PDU sets and Split PDU Sets: for example, identifying the PDU sets belong to a media stream using SID identifier present in the PDU set marking header; or, for example, identifying the media streams that can be split into multiple QoS flows and media streams that can be multiplexed into a single QoS flow and signaling that information to WTRU and UPF from AF.

A PDU set may have an identifier to help UPF and RAN identify the streams (like a stream ID). AS provides the stream identifier in RTP header extension (HE) for PDU set marking. An AS may add a stream identifier to the RTP HE for PDU set marking. A stream identifier related to a media may be identified from the SDP attribute with media id field or an AS/AF may generate a unique identifier for each media stream. A UPF may determine the stream ID of a specific media stream from the PDU set marking RTP HE and understands the PDU sets with a specific stream ID. UPF may signal the stream ID and or synchronization source ID (SSRC) present in the RTP header and the respective PDU sets to RAN.

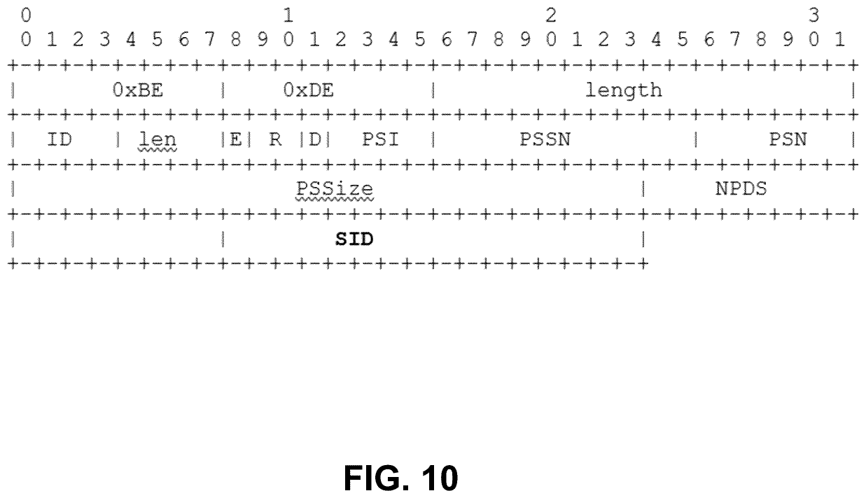

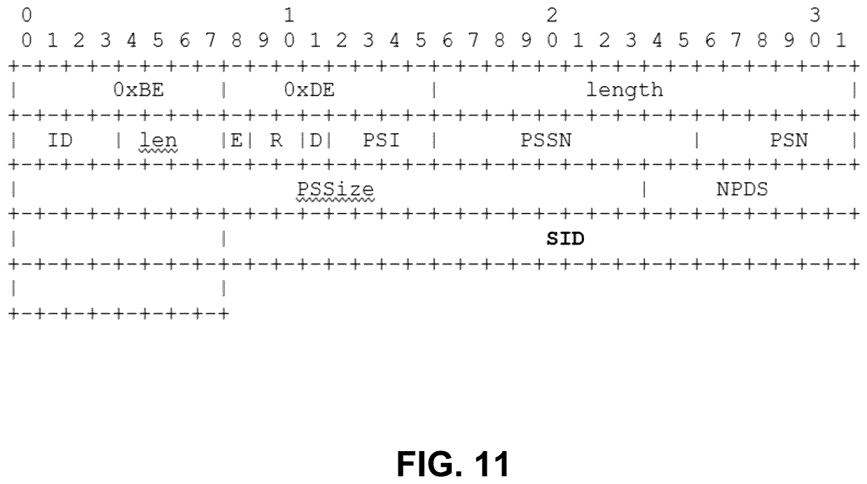

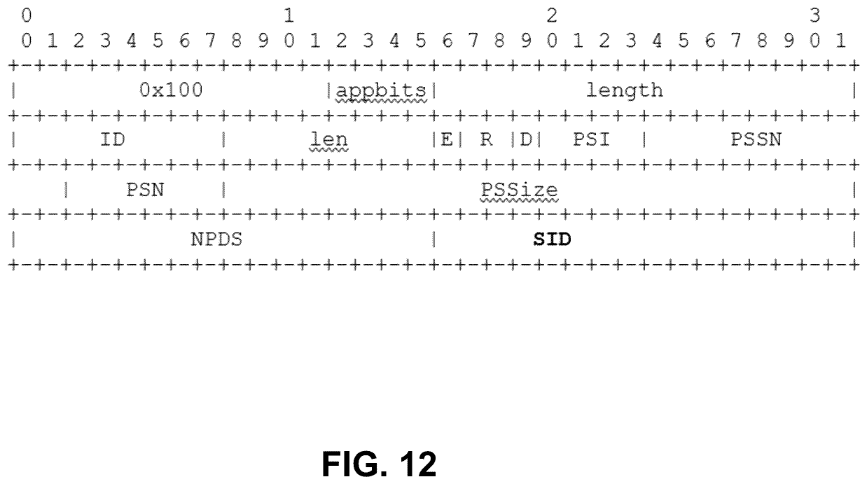

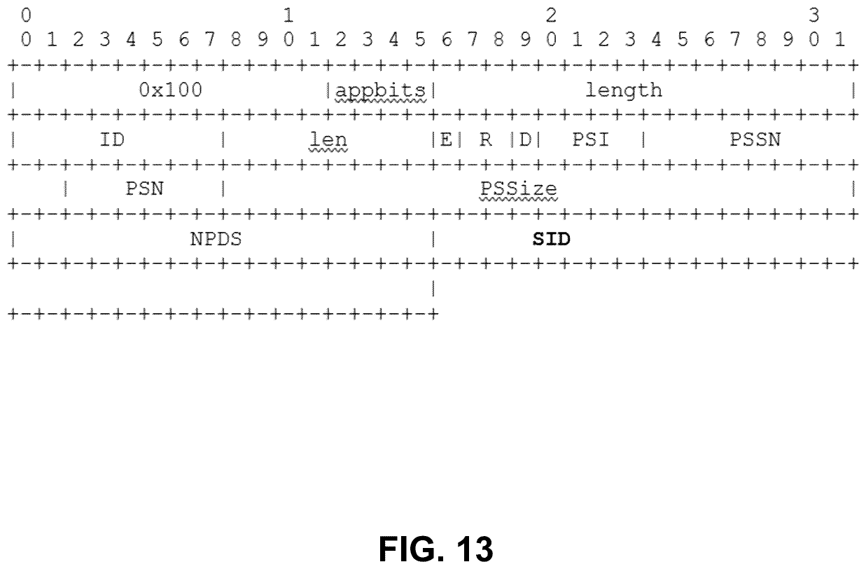

FIG. 10 illustrates an example one-byte RTP Header Extension for the marking of PDU Sets and the stream ID. FIG. 11 illustrates an example one-byte RTP Header Extension for the marking of PDU Sets and the stream ID. FIG. 12 illustrates an example two-byte RTP Header Extension for the marking of PDU Sets and the stream ID. FIG. 13 illustrates an example two-byte RTP Header Extension for the marking of PDU Sets and the stream ID.

The semantics of the stream ID field of the RTP Header Extension for the marking of PDU Set may be described as follows. Stream ID [SID] (16 bits or 32 bits): this field may indicate a (e.g., unique) identifier for the media present in an RTP packet. It may be used for identifying media streams within an RTP session. This field may be optional and may be subject to an SDP signaling offer/answer negotiation, where the RTP sender may indicate whether it will provide the media stream identifier of the PDU Set for that RTP stream. If not enabled, the field may not be present within the RTP Header Extension. If enabled, and the RTP sender is unable to provide the media stream identifier of a particular PDU Set, it may set the value to 0 in (e.g., all) PDUs of that PDU Set. The stream identifier value may be generated by the AS/AF or may be obtained from the ‘mid’ and/or ‘ssrc’ attribute value present in the SDP.

In an example, information associated with the streams that are split across two or more Qos flows may be signaled. In an example, information associated with the streams that are multiplexed into a single QoS flow may be signaled. When a media stream is split across two or more QoS flows, this information may be signaled to UPF from the AS or AF. This information may be conveyed to the WTRU, for example to indicate to the WTRU that the media stream data is available from different QoS flows. When two or more media streams are multiplexed into a single QoS flow, this information may be signaled to the UPF from the AS or AF. The UPF may identify the PDU sets in that QoS flow (e.g., the single QoS flow) using the stream ID, and the UPF may obtain the PDU sets belonging to the respective media stream, for example, for a differentiated QoS handling.

The UPF and RAN nodes may be provided with one or more of the following pieces of information: whether a stream can be split across multiple QoS flows; when a stream is split, the stream ID of the media stream which can be split across multiple QoS flows; whether multiple streams can be multiplexed into a single QoS flow; or when multiple streams are multiplexed into a single QoS flow, and the list of stream IDs of the media streams that may be multiplexed into a single QoS flow.

The M5RTCFlowInformation type structure (e.g., as part of M5QoSSpecification) may include the PDU set marking information of a media flow. This structure may be extended to provide the information, such as media stream identifier present in an RTP session, or whether a media stream is split into multiple QoS flows or multiple media streams are multiplexed into a single QoS flow.

Table 2 may be associated with M5QoSSpecification type.

TABLE 2
M5QoSSpecification type

| Property name | Data type | Cardinality | Description |
|---|---|---|---|
| downlinkBitRates | M5BitRateSpecification | 1 . . . 1 | Bit rate specification for the |
| | | | downlink direction |
| uplinkBitRates | M5BitRateSpecification | 1 . . . 1 | Bit rate specification for the uplink |
| | | | direction |
| desiredPacketLatency | number | 0 . . . 1 | Desired packet latency in |
| | | | milliseconds, expressed as a |
| | | | positive floating-point value. |
| desiredPacketLossRate | PacketLossRate | 0 . . . 1 | Desired packet loss rate expressed |
| | | | in tenth of a percent. |
| rtcQoSInformation | array(M5RTCFlowInformation) | 0 . . . 1 | For RTC sessions, individual flow |
| | | | information is provided. The |
| | | | aggregate uplink and downlink |
| | | | QoS parameters shall conform to |
| | | | the values specified in the above |
| | | | fields. |

Packet latency and packet loss may be (e.g., adjusted) to be the same in the downlink and uplink directions for a given MediaComponent when the CHEM feature is not supported by the PCF.

Table 3 may be associated with M5RTCFlowInformation type.

TABLE 3
M5RTCFlowInformation type

| Property name | Data type | Cardinality | Description |
|---|---|---|---|
| medialdentifier | string | 1 . . . 1 | Provides an identifier for the media stream to associate with |
| | | | the corresponding service component in the |
| | | | serviceDataFlowDescriptions of the Dynamic Policy |
| | | | resource. |
| marBwDIBitRate | BitRate | 1 . . . 1 | Maximum requested bit rate for the Downlink. |
| marBwUIBitRate | BitRate | 1 . . . 1 | Maximum requested bit rate for the Uplink. |
| minDesBwDIBitRate | BitRate | 0 . . . 1 | Minimum desired bit rate for the Downlink. |
| minDesBwUIBitRate | BitRate | 0 . . . 1 | Minimum desired bit rate for the Uplink. |
| mirBwDIBitRate | BitRate | 1 . . . 1 | Minimum requested bit rate for the Downlink. |
| mirBwUIBitRate | BitRate | 1 . . . 1 | Minimum requested bandwidth for the Uplink. |
| desLatency | integer | 0 . . . 1 | Desired Latency. |
| desLoss | integer | 0 . . . 1 | Desired Loss Rate. |
| desPduSetParameters | PduSetQosPara | 0 . . . 1 | Desired PDU Set QoS parameters. |
| pduSetMarking | PDUSetMarking | 0 . . . 1 | An object that contains the PDU Set marking configuration |
| | | | information for use by the Media Client. |

PDUSetMarking type: in examples, the PDUSetMarking type may be extended to include the media stream information by adding the StreamInfo type as shown in Table 4.

TABLE 4
Definition of PDUSetMarking type

| Property name | Data type | Cardinality | Description |
|---|---|---|---|
| headerExtensionInfo | RtpHeaderExtInfo | 0 . . . 1 | Configuration information of the RTP header |
| | | | extension used for PDU Set marking as specified |
| | | | in clause 5.5.4.14 of TS 29.571 [29571]. |
| mediastreamsInfo | Array(StreamInfo) | 0 . . . 1 | Information of a media stream present a media |
| | | | session or information of all the media streams |
| | | | present in a media session. |

Table 5 may be associated with StreamInfo type. In examples, the StreamInfo type may be defined to provide the information such as the media stream identifier, whether a media stream is split into multiple flows or not, and if multiple media streams can be multiplexed with this media stream or not, and the list of other media stream identifiers that may be multiplexed with a specific media stream in a Qos flow.

TABLE 5
StreamInfo type

| Property name | Data type | Cardinality | Description |
|---|---|---|---|
| splitintomultipleflows | boolean | 0 . . . 1 | Indicates if the media stream data is split into |
| | | | multiple flows or not. |
| streamId | Uint32 or | 0 . . . 1 | Indicates the media stream identifier value. This |
| | Unit16 | | field indicates a unique identifier value of a media |
| | | | stream present in a media streaming session. |
| multiplexedstreams | boolean | 0 . . . 1 | Indicates if this media stream data is multiplexed |
| | | | with other media streams data into a single flow or not. |
| multiplexedstreamIds | Array(Uint32 | 0 . . . 1 | Indicates the list of media stream identifiers that |
| | or Unit16) | | may be multiplexed with this media stream which is |
| | | | identified using the stream identifier streamId. |
| | | | When multiplexedflows flag is false, this field shall |
| | | | not be present or set to zero. |

In examples, when the PDU Set marking is enabled for the selected Policy Template through mediaTransportParameters, the ServiceDataFlowDescription.mediaTransportParameters property may be extended as follows.

The transportProto property may be set to the value RTP or SRTP, as applicable. The rtpHeaderExt property may be populated as follows: RtpHeaderExtInfo.rtpHeaderExtType may be set to PDU_SET_MARKING. RtpHeaderExtInfo.rtpHeaderExtId may be set to the value of the ID field to be used by the RTC endpoint (Media Client) in the RTP Header Extension for PDU Set Marking on the application flow in question. RtpHeaderExtInfo.longFormat may be set to reflect the use of the one- or two-byte RTP Header Extension for PDU Set Marking. RtpHeaderExtInfo.pduSetSizeActive may be set to reflect the presence of the PDU Set Size field in the RTP Header Extension for PDU Set Marking.

The rtpPayloadInfoList property may include a single member populated as follows: RtpPayloadInfo.rtpPayloadFormat may be set to a codec (e.g., H264 or H265), as applicable to the(S) RTP session(s) carried by the application flow in question. RtpPayloadInfo.rtpPayloadTypeList may be set to the RTP Payload Type value(s) to be used by the RTC endpoint (Media Client) for the RTP session(s) carried by the application flow in question.

The streamInfo property may include information of all the media streams present in the media session. streamInfo.splitintomultipleflows may be set to true when a media stream data is split into multiple flows otherwise set to false. streamInfo.streamId may indicate the media stream identifier value. This field may indicate a unique identifier value of a media stream present in a media streaming session. streamInfo.multiplexedstreams may be set to true when a media stream data is multiplexed with other media streams data into a single flow (or, for example, set to false otherwise). streamInfo.multiplexedstreamIds when streamInfo.multiplexedflows is set to true, this field may be set to the list of media stream identifiers that may be multiplexed with this media stream which is identified using the stream identifier streamInfo.streamId. When streamInfo.multiplexedstreams is false, this field may not be present or set to zero.

In examples, the ServiceDataFlowDescription type may be extended to include the media stream information by including the streamInfo property as below.

Table 6 may be associated with a ServiceDataFlowDescription type.

TABLE 6
ServiceDataFlowDescription type

| Property name | Data type | Cardinality | Description |
|---|---|---|---|
| sdfMethod | SdfMethod | 1 . . . 1 | The filtering method used to identify packets |
| | | | belonging to this Service Data Flow |
| flowDescription | IpPacketFilterSet | 0 . . . 1 | Service Data Flow Description. |
| domainName | string | 0 . . . 1 | FQDN of the Media AS. |
| mediaType | MediaType | 0 . . . 1 | The type of media carried by this Service Data |
| | | | Flow. |
| mediaTransportParameters | ProtocolDescription | 0 . . . 1 | The set of media transport protocol parameters |
| | | | to be used by the Core for the purpose of PDU |
| | | | Set identification and/or end of data burst |
| | | | detection. |
| mediastreamsInfo | Array(StreamInfo) | 0 . . . 1 | Information of a media stream present a media |
| | | | session or information of all the media streams |
| | | | present in a media session. |

NOTE 1:
Exactly one of these properties maybe populated.
NOTE 2:
Enumeration MediaType may be described herein.
NOTE 3:
Data type ProtocolDescription may be described herein.

Although features and elements are described above in particular combinations, one of ordinary skill in the art will appreciate that a feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

We claim:

1. A device comprising a processor configured to at least:
receive a first stream identifier (ID) associated with a first packet data unit (PDU) set, wherein the first stream ID is received in a PDU set marking header extension (HE);
determine, from the PDU set marking HE, that the first stream ID is associated with a first media stream; and
send at least the first stream ID identifying the first media stream and the first PDU set associated with the first stream ID.

2. The device of claim 1, wherein the first stream ID identifying the first media stream and the first PDU set associated with the first stream ID are sent to one or more of a user plane function (UPF), radio access network (RAN) node, or a media client.

3. The device of claim 1, wherein the processor is configured to generate the first stream ID, wherein the first stream ID is generated as part of one or more of a real time protocol (RTP) session negotiation or a provisioning session.

4. The device of claim 1, wherein the first stream ID is received by a user plane function (UPF) from an application server (AS) or an application function (AF).

5. The device of claim 1, wherein the first stream ID is received on a control plane.

6. The device of claim 1, wherein the first media stream associated with the first stream ID is multiplexed into a single QoS flow.

7. The device of claim 1, wherein the processor is configured to send an indication indicating that the first media stream is split into two or more quality of service (QOS) flows.

8. The device of claim 1, wherein the processor is configured to:
receive a second stream ID associated with a second PDU set;
determine that the second stream ID is associated with a second media stream; and
send the second stream ID identifying the second media stream and the second PDU set associated with the second stream ID.

9. The device of claim 1, wherein the processor is configured to send an indication indicating that the first media stream is multiplexed with a second media stream, wherein the first media stream and the second media stream are multiplexed into a quality of service (QOS) flow.

10. The device of claim 1, wherein the processor is configured to send a list of stream IDs multiplexed with the first media stream.

11. A method for a device, the method comprising at least:
receiving a first stream identifier (ID) associated with a first packet data unit (PDU) set, wherein the first stream ID is received in a PDU set marking header extension (HE);
determining, from the PDU set marking HE, that the first stream ID is associated with a first media stream; and
sending at least the first stream ID identifying the first media stream and the first PDU set associated with the first stream ID.

12. The method of claim 11, wherein the first stream ID identifying the first media stream and the first PDU set associated with the first stream ID are sent to one or more of a user plane function (UPF), a radio access network (RAN), node or a media client.

13. The device of claim 11, wherein the method comprises generating the first stream ID, and wherein the first stream ID is generated as part of one or more of a real time protocol (RTP) session negotiation or a provisioning session.

14. The method of claim 11, wherein the first stream ID is received by a user plane function (UPF) from an application server (AS) or an application function (AF).

15. The method of claim 11, wherein the first stream ID is received on a control plane.

16. The method of claim 11, wherein the first media stream associated with the first stream ID is multiplexed into a single QoS flow.

17. The method of claim 11, wherein the method comprises sending an indication indicating that the first media stream is split into two or more quality of service (QOS) flows.

18. The method of claim 11, wherein the method comprises:
receiving a second stream ID associated with a second PDU set;
determining that the second stream ID is associated with a second media stream; and
sending the second stream ID identifying the second media stream and the second PDU set associated with the second stream ID.

19. The method of claim 11, wherein the method comprises sending an indication indicating that the first media stream is multiplexed with a second media stream, and wherein the first media stream and the second media stream are multiplexed into a quality of service (QOS) flow.

20. The method of claim 11, wherein the method comprises sending a list of stream IDs multiplexed with the first media stream.
